(19) United States
(12) Patent Application Publication
(10) Pub. No.: US 2014/0150747 A1
(43) Pub. Date: Jun. 5, 2014

(54) PISTON FOR AN INTERNAL COMBUSTION ENGINE AND METHOD FOR PRODUCING THE PISTON

(71) Applicant: Roland Lochmann, Marbach (DE)

(72) Inventor: Roland Lochmann, Marbach (DE)

(73) Assignee: MAHLE INTERNATIONAL GMBH, Stuttgart (DE)

(21) Appl. No.: 14/119,498

(22) PCT Filed: May 25, 2012
(86) PCT No.: PCT/DE2012/000547

§ 371 Date: Dec. 9, 2013

(30) Foreign Application Priority Data
May 25, 2011 (DE) 10 2011 103 105.0

(51) Int. Cl. F02F 3/00

(52) U.S. Cl. CPC F02F 3/0015
USPC 123/193.6; 29/888.04

(57) ABSTRACT

A piston for an internal combustion engine, has a piston crown, two pin bosses, and pin bores introduced into the pin bosses. Respective lubricating grooves are formed in the nadir and equator regions of the pin bores. In order to improve the lubrication of the pins, the lubricating grooves are arranged in the radially inner edge area of the respective pin bore and additionally in a plane lying at an angle to the piston axis, such that the lubricating grooves open into the radial inner faces of the pin bosses, where lubricating oil can enter the lubricating grooves. The lubricating grooves are produced by a lathe tool, the rotational axis of which is tilted relative to the pin bore axis and which is moved in a direction pointing away from the piston crown during the turning.

The invention relates to piston for an internal combustion engine, having a piston crown, having a ring belt disposed in the vicinity of the piston crown, on the radial outside of the piston, having two pin bosses that follow the ring belt in the direction facing away from the piston crown and lie opposite one another, which bosses are connected with one another by way of skirt elements, and having a pin bore introduced into the pin bosses, in each instance, whereby at least one lubrication groove is formed in the nadir region and the equator region of the pin bores, in each instance.

A piston of the type indicated initially is known from the Offenlegungsschrift [unexamined patent application published for public scrutiny] DE 102 55 731 A1. It is disadvantageous, in this connection, that the lubrication grooves are disposed in the central region of the pin bores, so that during engine operation, they are only slowly filled with lubricant oil. A further disadvantage of the lubrication grooves known from the state of the art consists in that a lathe tool that is put into rotation and has to be deflected to such an extent, in the region of the lubrication groove, until the desired depth of the lubrication groove is thereby reached, is used for their production.

Accordingly, it is the task of the invention to avoid the disadvantages of the state of the art, and, for one thing, to equip a piston with lubrication grooves that can easily be filled with lubricant. For another thing, it is the task of the invention to simplify the production of the lubrication grooves.

This task is accomplished, for one thing, in that the at least one lubrication groove is disposed in the radially inner and/or in the radially outer edge region of the pin bore, in each instance, and that the lubrication groove plane lies at a slant relative to the piston axis, so that the at least one lubrication groove opens into the radial inside and/or into the radial outside of the pin boss, in each instance. If a pin is situated in the pin bore, openings on the inside and/or on the outside of the pin bosses thereby occur, through which the lubricant oil can penetrate into the pin bores and thereby improves lubrication of the pin.

For another thing, the task is accomplished in that only a conventional lathe tool mounted so as to rotate needs to be introduced into the pin bore for production of the lubrication grooves, and afterward, the lathe tool is positioned at the location of the pin bore at which a lubrication groove is to be introduced. Subsequently, all that is required is to displace the rotating lathe tool into a direction facing away from the piston crown or to displace the piston relative to the lathe tool, until the lubrication groove has the desired depth. If necessary, the axis of rotation of the lathe tool relative to the pin bore axis, or the piston relative to the axis of rotation of the lathe tool, has to be tilted by a slight angle, in order to produce lubrication grooves that open into the radial inside or into the radial outside of the pin bosses.

Advantageous further developments of the invention are the object of the dependent claims.

Some exemplary embodiments of the invention will be described below, using the drawings. These show:

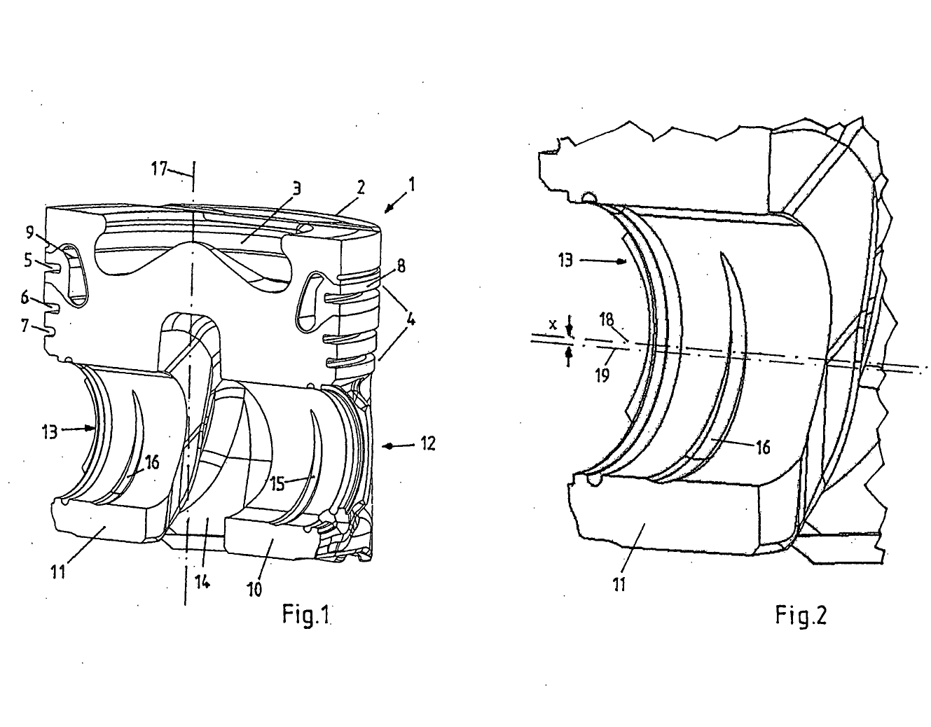

FIG. 1 the sectional view of a piston having pin bores, each having a lubrication groove,

FIG. 2 an enlarged representation of a pin bore according to FIG. 1,

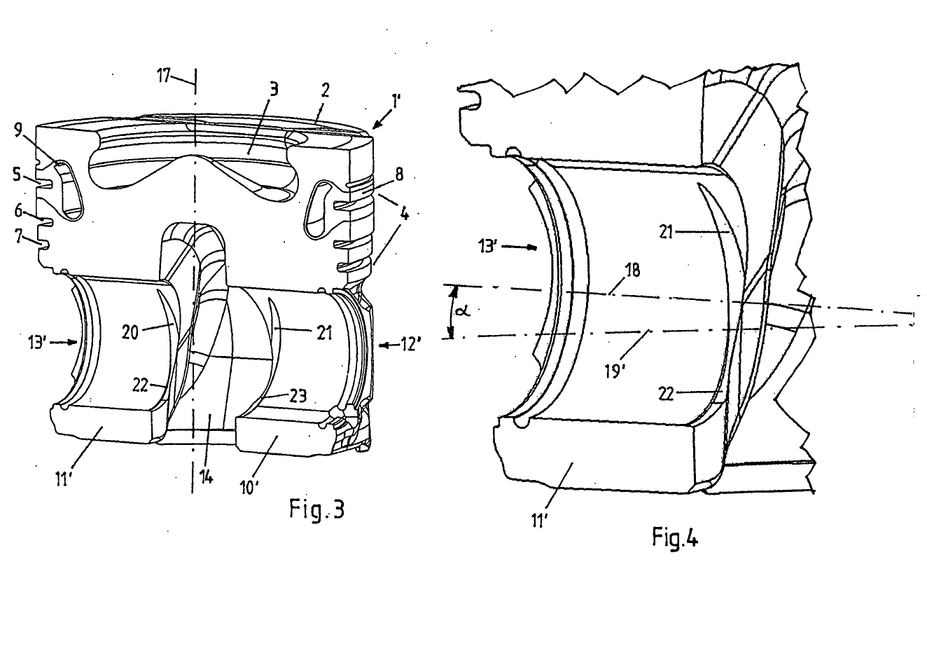

FIG. 3 a piston in section, the pin bores of which each have a lubrication groove each having an opening that lies on the inside,

FIG. 4 an enlarged representation of a pin bore according to FIG. 3,

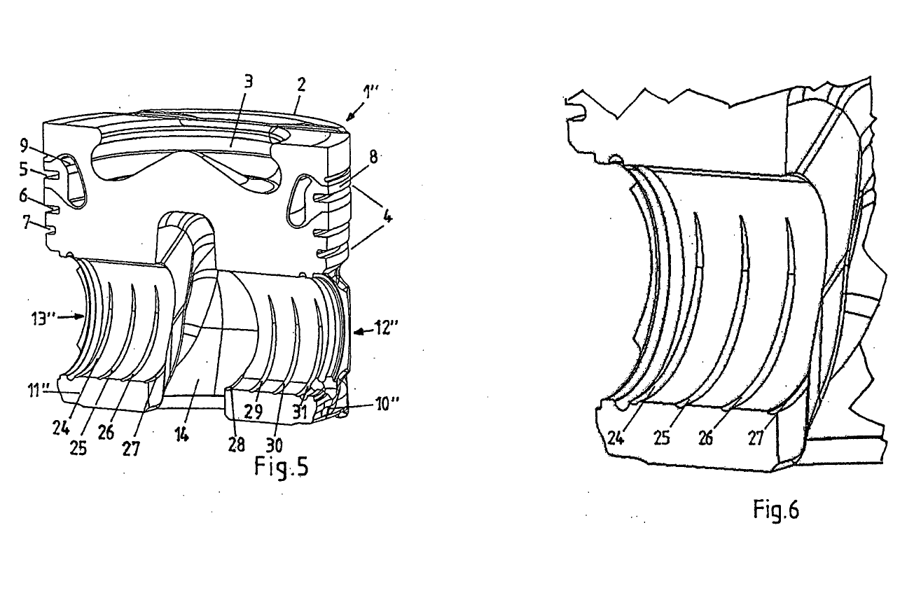

FIG. 5 a piston, in section, having pin bores that each have multiple lubrication grooves disposed in parallel and lying at a slant relative to the piston axis, and

FIG. 6 an enlarged representation of a pin bore according to FIG. 5.

FIGS. 1, 3 and 5 each show a piston 1, 1′, 1″ in section, having a piston crown 2 in which a combustion bowl 3 is formed. The piston 1, 1′ 1″ has a ring belt 4 radially on the outside, in the vicinity of the piston crown, having three ring grooves 5, 6, 7, of which the ring groove 5, which lies closest to the piston crown, is provided for a compression ring and provided with a ring insert 8 on which a circumferential cooling channel 9 is formed radially on the inside.

In the direction facing away from the piston crown, two pin bosses 10, 10′, 10″, 11, 11′, 11″ follow the ring belt 4, each having a pin bore 12, 12′, 12″, 13, 13′, 13″, whereby the two pin bores 12, 12′, 12″ and 13, 13′, 13″ are disposed coaxially. Radially on the outside, the pin bosses 10, 10′, 10″, 11, 11′, 11″ are connected by circumferential skirt elements 14, of which only the inside surfaces of one of the skirt elements 14 can be seen in FIGS. 1, 3, and 5, because of the position of the section.

A lubrication groove 15, 16 is worked into the center of the inner surfaces of the pin bores 12, 13 according to FIG. 1, in each instance, which grooves run by way of the nadir and the equator of the pin bore 12, 13, in each instance. In the present exemplary embodiment, the lubrication grooves 15, 16 cover an angle range of approximately 270°, in each instance. The angle range can lie between 180° and 360°. The depth of the lubrication grooves 15, 16 amounts to between 1 μm and 500 μm. The lubrication grooves 15, 16 are disposed in a plane that lies parallel to the piston axis 17 and perpendicular to the pin bore axis 18 (FIG. 2).

A conventional lathe having a lathe tool mounted so as to rotate is used for the production of the lubrication grooves 15, 16; its cutting surface, which is suitable for the present task, is disposed radially on the outside.

For a further explanation of the production of the lubrication grooves 15, 16, reference is made to FIG. 2. For the production of a lubrication groove 16 as it is shown in FIG. 2, for example, first the lathe tool is disposed in the pin bore 13 in such a manner that its axis of rotation lies on the pin bore axis 18. The lathe tool is put into rotation, whereby the radial dimension of the lathe tool is such that no contact with the inner wall of the pin bore 13 take place in this connection.

Subsequently, the axis of rotation of the lathe tool is displaced in the direction in which the lubrication groove 16 is provided. This direction can lie parallel to the piston axis 17 and can point away from the piston crown 2, if the lubrication groove is supposed to cover the nadir region and the equator region of the pin bore 13.

However, this direction can also lie at a slant relative to the piston axis 17, whereby it is advantageous if this direction corresponds to the connecting rod axis when the connecting rod is in the position that applies the ignition pressure maximum of the work cycle to the piston 1 and thereby to the connecting rod during engine operation. This brings with it the advantage that the specific zenith region of the pin bore 13 that is exposed to the maximal pressure stress during the work cycle is not provided with a lubrication groove 16 and thereby has a maximal contact surface, so that in this region, the wear of the pin bore 13 and of the pin situated in it is minimized.

When the lubrication groove 16 has been completed after the end of the lathing process, the axis of rotation 19 of the lathe tool lies in a position, for example, as shown in FIG. 2. In this connection, the distance “X” between the pin bore axis 18 and the axis of rotation 19 of the lathe tool has a size that lies between half the depth and the entire depth of the lubrication groove 16.

This depends on the extent to which the distance between the cutting surface of the lathe tool and the axis of rotation 19 of the lathe tool is increased during displacement of the axis of rotation of the lathe tool, whereby the degree of increase of this distance is the deciding factor, for one thing, for the angle range of the pin bore inner surface over which the lubrication groove 16 extends. For another thing, the increase in the distance determines the depth of the lubrication groove 16.

If, for example, the increase in the distance between the cutting surface of the lathe tool and the axis of rotation 19 of the lathe tool precisely corresponds to the distance “X” between the pin bore axis 18 and the axis of rotation 19 of the lathe tool, the lubrication groove 16 extends over an angle range of 360° and the depth of the lubrication groove 16 in the nadir region amounts to twice the distance “X.”

If the distance between the cutting surface of the lathe tool and the axis of rotation 19 of the lathe tool is kept constant, the lubrication groove 16 extends over a nadir region and equator region of 180°, and the depth of the lubrication groove in the nadir region corresponds to precisely the distance “X” between the pin bore axis 18 and the axis of rotation 19 of the lathe tool. In practice, simple experiments are needed, in this connection, in order to be able to adjust the lathe tool in accordance with the existing requirements and to obtain the desired angle range over which the lubrication groove 15, 16 extends.

In this connection, it is also possible to displace the piston 1 instead of the lathe tool, in order to bring the cutting surface of the lathe tool into contact with the inner surface of the pin bore and to cause it to form a lubrication groove in the inner surface of the pin bore. In this connection, the piston 1 is displaced in such a direction that the distance between the axis of rotation 19 and the piston crown 2 is increased.

In FIGS. 3 and 4, lubrication grooves 20 and 21 disposed on the radial insides of the pin bores 12′ and 13′ are shown, which are disposed in two planes that lie at a slant relative to the piston axis 17, whereby the two planes run toward one another in the direction facing away from the piston crown, so that the lubrication grooves 20 and 21 open into the radial insides of the pin bosses 10′ and 11′ in the vicinity of the nadir of the pin bores 12′ and 13′. When a pin is situated in the pin bores 12′ and 13′, openings therefore occur in the end regions 22 and 23 of the lubrication grooves 20 and 21, through which oil penetrates into the lubrication grooves 20 and 21 as a result of the capillary effect and the movements of the pin in the pin bore, and thereby improves the lubrication of the pin in the pin bores 12′ and 13′.

Reference is made to FIG. 4 with regard to production of the lubrication grooves 20 and 21. In the production of the lubrication groove 21, for example, the lathe tool is introduced into the pin bore 13′, and the axis of rotation 19′ of the lathe tool is tilted by an angle α that amounts to 5° in the present exemplary embodiment. This angle α can amount to between 5° and 30°. Subsequently, the lathe tool is put into rotation and, as was already described above with regard to production of the lubrication grooves 15 and 16, in the direction of the piston axis 17 or set at a slant to it.

In this connection, the piston can also be tilted by the angle α instead of the lathe tool. In order to subsequently lathe a lubrication groove 15, 16 into the inner surface of the pin bore, now either the piston or the lathe tool can be displaced until the cutting surface of the lathe tool comes into contact with the inner surface of the pin bore, and a lubrication groove 15, 16 can be lathed into the pin bore.

In FIGS. 5 and 6, the pin bores 12″ and 13″ according to the present exemplary embodiment each have four lubrication grooves 24 to 31.

The advantage of this consists in that the lubricant holding capacity of the pin bores 12″ and 13″ is also increased by increasing the number of lubrication grooves, and thereby the lubrication of the piston pin is improved. Furthermore, oil collects in the center lubrication grooves 25, 26, 29, 30, which remains in the lubrication grooves 25, 26, 29, 30 even when the engine is stopped, and thereby improves the cold-start conditions of the engine.

Production takes place as explained for the lubrication grooves 15, 16, 20, 21, with the difference that the lathe tool must be put in place multiple times per pin bore 12″, 13″, and forms each individual lubrication groove 24 to 31 in the pin bores 12″, 13″ as described above.

Another possibility of lathing multiple lubrication grooves 24 to 31 that lie next to one another into the pin bores 12″, 13″ consists in first positioning the lathe tool in front of the pin bore 12″, 13″, to such an extent that the axis of rotation of the lathe tool lies coaxial to the pin bore axis 18, and then displacing the axis of rotation of the lathe tool relative to the piston, or the piston relative to the lathe tool, until a sufficient distance between the pin bore axis and the axis of rotation of the lathe tool has come about, in order to subsequently guide the turning lathe tool through the pin bore in the direction of its axis of rotation.

In this connection, the distance between the cutting surface of the lathe tool and the axis of rotation of the lathe tool must be selected in such a manner that the cutting surface of the lathe tool exclusively comes into contact with the nadir and the equator of the pin bore, and multiple lubrication grooves that lie next to one another on the side of the pin bore facing away from the piston crown are formed into the inner surface of the pin bore. The number of lubrication grooves produced in this way is also dependent, in this connection, on the speed of rotation and the advancing speed of the lathe tool, whereby these speeds must be adjusted in accordance with the desired number of lubrication grooves.

In this connection, bearing bushings can also be pressed into the pin bores, so that the lubrication grooves are formed in the inner surfaces of the bearing bushings. The bores of the bearing bushings then correspond to the pin bores, as far as the arrangement and the production of the lubrication grooves are concerned.

### REFERENCE SYMBOL LIST

X distance between the pin bore axis 18 and the axis of rotation 19 of the lathe tool
1, 1′, 1″ piston
2 piston crown
3 combustion bowl
4 ring belt
5, 6, 7 ring groove
8 ring insert
9 cooling channel
10, 10′, 10″, 11, 11′, 11″ pin boss
12, 12′, 12″, 13, 13′, 13″ pin bore
14 skirt element
15, 16 lubrication groove
17 piston axis
18 pin bore axis
19, 19′ axis of rotation of the lathe tool
20, 21 lubrication groove
22, 23 end region of the lubrication groove 20, 21
24 to 31 lubrication groove

1. Piston (1, 1′, 1″) for an internal combustion engine, having a piston crown (2), having a ring belt (4) disposed in the vicinity of the piston crown, on the radial outside of the piston (1, 1′, 1″), having two pin bosses (10, 10′, 10″, 11, 11′, 11″) that follow the ring belt (4) in the direction facing away from the piston crown and lie opposite one another, which bosses are connected with one another by way of skirt elements (14), and having a pin bore (12, 12′, 12″, 13, 13′, 13″) introduced into the pin bosses (10, 10′, 10″, 11, 11′, 11″), in each instance, wherein at least one lubrication groove (15, 16, 20, 21, 24 to 31) is formed in the nadir region and the equator region of the pin bores (12, 12′, 12″, 13, 13′, 13″), in each instance
wherein the at least one lubrication groove (20, 21, 24 to 31) is disposed in the radially inner and/or in the radially outer edge region of the pin bore (12′, 12″, 13′, 13″), in each instance, and wherein the lubrication groove plane lies at a slant relative to the piston axis (17), so that the at least one lubrication groove (20, 21, 24 to 31) opens into the radial inside and/or into the radial outside of the pin boss (10′, 10″, 11′, 11″), in each instance.

2. Piston (1′) for an internal combustion engine according to claim 1, wherein a lubrication groove (20, 21) is disposed in the radially inner region of the pin bores (12′, 13′), in each instance, wherein the lubrication grooves (20, 21) lie in planes that run toward one another in the direction facing away from the piston crown, so that the lubrication grooves (20, 21) open into the radial insides of the pin bosses (10′, 11′), in each instance, in the vicinity of the nadir of the pin bores (12, 12′).

3. Piston (1″) for an internal combustion engine according to claim 1, wherein a lubrication groove (27, 28) is disposed in the radially inner region, and a lubrication groove (24, 31) is disposed in the radially outer region of the pin bores (12″, 13″), in each instance.

4. Piston (1″) for an internal combustion engine according to claim 3, wherein at least one further lubrication groove (25, 26, 29, 30) is disposed between the radially inner and the radially outer lubrication grooves (24, 27, 28, 31), per pin bore (12″, 13″), in each instance.

5. Piston (1, 1′, 1″) for an internal combustion engine according to claim 1, wherein the lubrication grooves (15, 16, 20, 21, 24 to 31) cover an angle range of the pin bore (12, 12′, 12″, 13, 13′, 13″) of 180° to 360°.

6. Piston (1, 1′, 1″) for an internal combustion engine according to claim 1, wherein the lubrication grooves (15, 16, 20, 21, 24 to 31) cover an angle range of the pin bore (12, 12′, 12″, 13, 13′, 13″) of 180° to 300°.

7. Piston (1, 1′, 1″) for an internal combustion engine according to claim 1, wherein the lubrication grooves (15, 16, 20, 21, 24 to 31) cover an angle range of the pin bore (12, 12′, 12″, 13, 13′, 13″) of 180° to 240°.

8. Piston (1, 1′, 1″) for an internal combustion engine according to claim 1, wherein the lubrication grooves (15, 16, 20, 21, 24 to 31) have a depth of 1 μm to 500 μm.

9. Piston (1, 1′, 1″) for an internal combustion engine according to claim 1, wherein the lubrication grooves (15, 16, 20, 21, 24 to 31) have a depth of 100 μm to 200 μm.

10. Method for the production of a piston (1, 1′, 1″) for an internal combustion engine, having a piston crown (2), having a ring belt (4) disposed in the vicinity of the piston crown, on the radial outside of the piston (1, 1′, 1″), having two pin bosses (10, 10′, 10″, 11, 11′, 11″) that follow the ring belt (4) in the direction facing away from the piston crown and lie opposite one another, which bosses are connected with one another by way of skirt elements (14), and having a pin bore (12, 12′, 12″, 13, 13′, 13″) introduced into the pin bosses (10, 10′, 10″, 11, 11′, 11″), in each instance, comprising the following method steps:
introducing a lathe tool of a lathe, mounted so as to rotate, which tool has a cutting surface disposed radially on the outside, into the pin bore (12, 12′, 12″, 13, 13′, 13″),
positioning the lathe tool at the location of the pin bore (12, 12′, 12″, 13, 13′, 13″) at which a lubrication groove (15, 16, 20, 21, 24 to 31) is to be introduced,
displacing the rotating lathe tool in a direction facing away from the piston crown (2), until the lubrication groove (15, 16, 20, 21, 24 to 31) has the desired depth.

11. Method for the production of a piston (1′, 1″) for an internal combustion engine according to claim 10, wherein the axis of rotation (19′) of the rotating lathe tool is tilted by an angle α between 5° and 30° relative to the pin bore axis (18), before the lathe tool is displaced.

12. Method for the production of a piston (1, 1′, 1″) for an internal combustion engine, having a piston crown (2), having a ring belt (4) disposed in the vicinity of the piston crown, on the radial outside of the piston (1, 1′, 1″), having two pin bosses (10, 10′, 10″, 11, 11′, 11″) that follow the ring belt (4) in the direction facing away from the piston crown and lie opposite one another, which bosses are connected with one another by way of skirt elements (14), and having a pin bore (12, 12′, 12″, 13, 13′, 13″) introduced into the pin bosses (10, 10′, 10″, 11, 11′, 11″), in each instance, comprising the following method steps:
introducing a lathe tool of a lathe, mounted so as to rotate, which tool has a cutting surface disposed radially on the outside, into the pin bore (12, 12′, 12″, 13, 13′, 13″),
positioning the lathe tool at the location of the pin bore (12, 12′, 12″, 13, 13′, 13″) at which a lubrication groove (15, 16, 20, 21, 24 to 31) is to be introduced,
displacing the piston (1, 1′, 1″) relative to the rotating lathe tool, in such a direction that the distance between the lathe tool and the piston crown (2) increases, until the lubrication groove (15, 16, 20, 21, 24 to 31) has the desired depth.

13. Method for the production of a piston (1′, 1″) for an internal combustion engine according to claim 12, wherein the piston (1′, 1″) is tilted by an angle α between 5° and 30° relative to the rotating lathe tool, before the piston (1′, 1″) is displaced.

14. Method for the production of a piston (1, 1′, 1″) for an internal combustion engine according to claim 10, wherein the rotating lathe tool is displaced in a direction that corresponds to the direction of the longitudinal axis of a connecting rod connected with the piston (1, 1′, 1″) when the connecting rod is in the position in which the ignition pressure maximum acts on the connecting rod during engine operation.

15. Method for the production of a piston (1″) for an internal combustion engine, having a piston crown (2), having a ring belt (4) disposed in the vicinity of the piston crown, on the radial outside of the piston (1″), having two pin bosses (10″, 11″) that follow the ring belt (4) in the direction facing away from the piston crown and lie opposite one another, which bosses are connected with one another by way of skirt elements (14), and having a pin bore (12″, 13″) introduced into the pin bosses (10″, 11″), in each instance, comprising the following method steps:
positioning the lathe tool in front of the pin bore (12″, 13″), to such an extent that the axis of rotation of the lathe tool lies parallel to the pin bore axis (18) and lies farther away from the piston crown (2) by 1 μm to 500 μm than the pin bore axis (18),
guiding the rotating lathe tool through the pin bore (12″, 13″) in the direction of the pin bore axis (18), wherein the distance between the cutting surface of the lathe tool and the axis of rotation of the lathe tool is selected in such a manner that the lathe tool exclusively comes into contact with the nadir and the equator of the pin bore, and that in this connection, lubrication grooves (24 to 31) occur in the nadir and in the equator of the pin bore (12″, 13″), which have a depth of 1 μm to 500 μm.
